(19) United States
(12) Patent Application Publication
(10) Pub. No.: US 2018/0054858 A1
(43) Pub. Date: Feb. 22, 2018

(54) THERMALLY CONDUCTIVE SKIN

(71) Applicant: Ford Global Technologies, LLC, Dearborn, MI (US)

(72) Inventor: Alan George Dry, Grosse Pointe Woods, MI (US)

(73) Assignee: Ford Global Technologies, LLC

(21) Appl. No.: 15/237,808

(22) Filed: Aug. 16, 2016

(51) Int. Cl. H05B 3/34; B32B 5/02; B32B 27/08; H05B 1/02; B60N 2/56

(52) U.S. Cl. CPC H05B 3/342; B32B 5/022; B32B 27/08; H05B 2203/029; B60N 2/5685; B32B 2307/302; B32B 2605/003; H05B 1/0238

(57) ABSTRACT

A thermally conductive skin includes a plurality of thermal electric devices disposed between, and in thermal contact with, an upper thermally conductive member and a lower thermally conductive member. The thickness of the thermally conductive skin is less than 25 mm. The thermal electric devices are separated from one another by thermal insulation.

### FIELD OF THE INVENTION

The present disclosure generally relates to a thermally conductive skin. More specifically, the present disclosure relates to a thermally conductive skin that is useful for heated and cooled surfaces, such as vehicle seats.

### BACKGROUND OF THE INVENTION

Heated and cooled surfaces are desirable in various fields of endeavor. Frequently, heated and cooled surfaces are sought in consumer products, such as vehicle seating assemblies, floors of buildings or homes, vehicle steering wheels, electric blankets, etc. However, current solutions for providing heated and cooled surfaces often can be too thick to conform to the contours of the substrates for which they are intended. Further, current solutions for providing heated and cooled surfaces can take extended periods of time to reach a user-perceptible temperature change.

### SUMMARY OF THE INVENTION

According to one aspect of the present disclosure, a thermally conductive skin includes a plurality of thermal electric devices positioned between an upper thermally conductive member and a lower thermally conductive member. The thermal electric devices are in thermal contact with the upper thermally conductive member and the lower thermally conductive member. The thermal electric devices are separated from one another by thermal insulation. A free-flow fluid layer is loosely attached to an underside of the lower thermally conductive member and positioned between the lower thermally conductive member and an air seal sheet. A supporting material abuts an underside of the air seal sheet.

According to another aspect of the present disclosure, a thermally conductive skin includes a plurality of thermal electric devices positioned between an upper thermally conductive member and a lower thermally conductive member. The thermal electric devices are in thermal contact with the upper thermally conductive member and the lower thermally conductive member. The thermal electric devices are separated from one another by thermal insulation. A supporting material abuts an underside of the lower thermally conductive member.

According to yet another aspect of the present disclosure, a thermally conductive skin includes a plurality of thermal electric devices positioned within a flexible thermally controlled sheet. The flexible thermally controlled sheet has a thickness of less than 25 mm. A supporting material abuts an underside of the flexible thermally controlled sheet.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side perspective view of a vehicle seating arrangement having seating assemblies in a front portion of a cabin of a vehicle;

FIG. 2 is a side perspective view of a vehicle seating arrangement having seating assemblies in a rear portion of a cabin of a vehicle;

FIG. 3 is a cross-sectional view, taken along the line of FIG. 1, illustrating one embodiment of a thermally conductive skin on the seating assembly;

FIG. 4 is a cross-sectional view, taken along the line similar to FIG. 3, showing a different section of the embodiment of a thermally conductive skin;

FIG. 5 is a cross-sectional view, taken along the line of yet another embodiment of a thermally conductive skin;

FIG. 6 is a cross-sectional view, taken along the line of yet another embodiment of a thermally conductive skin;

FIG. 7 is a cross-sectional view, taken along the line of still another embodiment of a thermally conductive skin;

FIG. 8 is a cross-sectional view, taken along the line of an additional embodiment of a thermally conductive skin;

FIG. 9 is a detailed view of one embodiment of a thermal electric device that may be used in the thermally conductive skin; and

FIG. 10 is a detailed view of another embodiment of a thermal electric device that may be used in the thermally conductive skin.

### DETAILED DESCRIPTION OF THE PREFERRED EMBODIMENTS

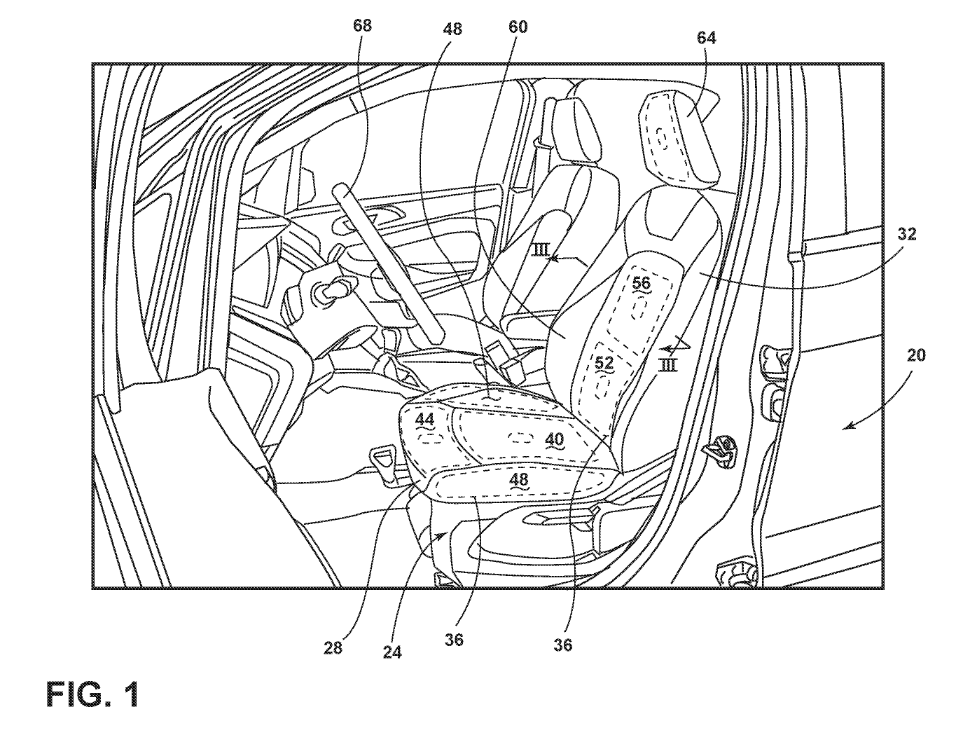

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a thermally conductive skin. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

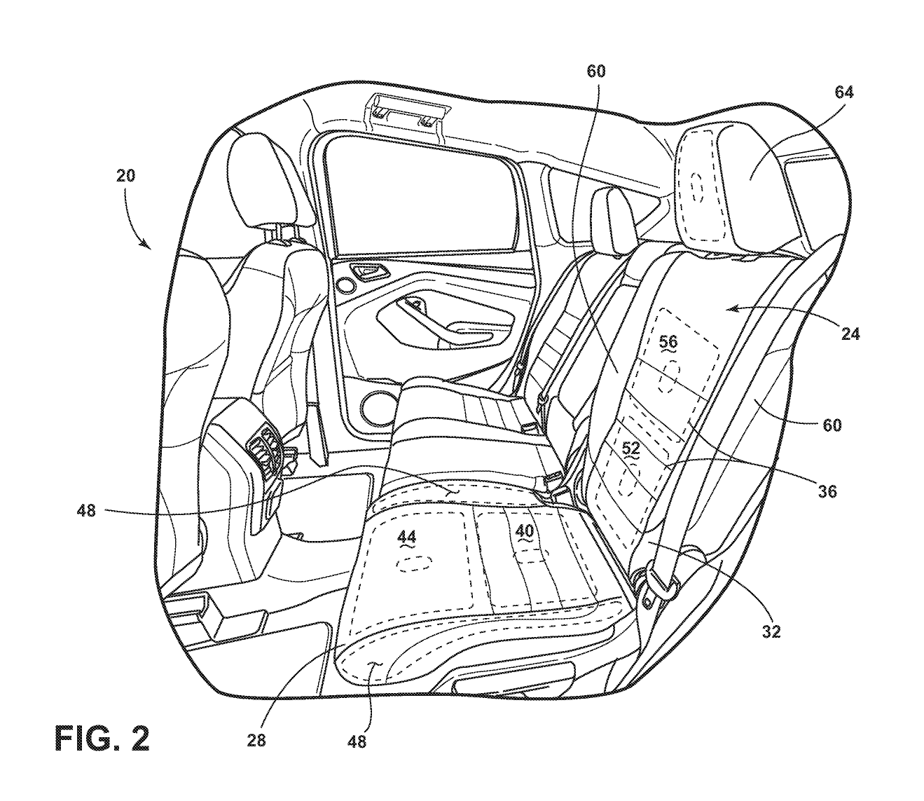

Referring to FIGS. 1-10, reference numeral 20 generally designates a vehicle, such as a wheeled motor vehicle. The vehicle 20 is shown having one or more vehicle seating assemblies 24, each having a seat 28 and a seatback 32. The vehicle seating assembly 24 is equipped with a thermally conductive skin 36 that is shown in phantom in FIGS. 1 and 2. The thermally conductive skin 36 is flexible and can be located at any desirable position on the vehicle seating assembly 24. For example, the thermally conductive skin 36 can be located where an occupant of the vehicle seating assembly 24 contacts the surface of the vehicle seating assembly 24. The flexibility of the thermally conductive skin 36 is such that the thermally conductive skin 36 deforms locally to the contours of the occupant of the vehicle seating assembly 24. This high degree of flexibility results in the presence of the thermally conductive skin 36 being imperceptible to the occupant. Additionally, the thermally conductive skin 36 can be positioned directly below the trim or fabric covering the vehicle seating assembly 24. Positioning the thermally conductive skin 36 so near the surface of the vehicle seating assembly 24 allows for rapid heating and/or cooling of the surface such that the occupant perceives a near-instantaneous user-perceptible temperature change upon heating or cooling activation of the thermally conductive skin 36. Locations of the thermally conductive skin 36 within the vehicle seating assembly 24 can include, but are not limited to, a central area 40 of the seat 28, a thigh area 44 of the seat 28, seat side bolsters 48, a lower back area 52 of the seatback 32, an upper back area 56 of the seatback 32, seatback side bolsters 60, and a headrest 64.

While shown as being utilized in the vehicle seating assembly 24, the thermally conductive skin 36 can be used elsewhere in the vehicle 20 or in other applications not related to vehicles without departing from the concepts disclosed herein. For example, the thermally conductive skin 36 can be used in steering wheels 68, cup holders, armrests, side-view mirrors, floor assemblies, heated and/or cooled blankets, wearable thermally controlled (i.e. heated and/or cooled) garments, such as gloves, shirts, pants, hats, jackets, socks, and the like. The thermally conductive skin 36 can be made of a variety of materials. Those materials include, but are not limited to, compressed, non-woven fibers. For example, polyesters can be used. More specifically, polyethylene terephthalate can be used.

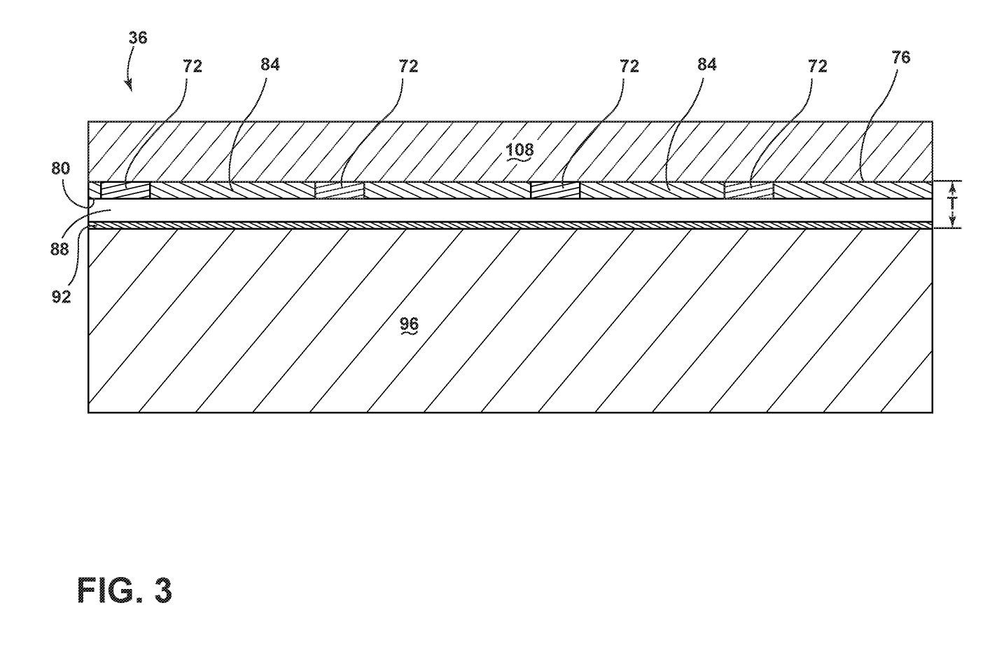

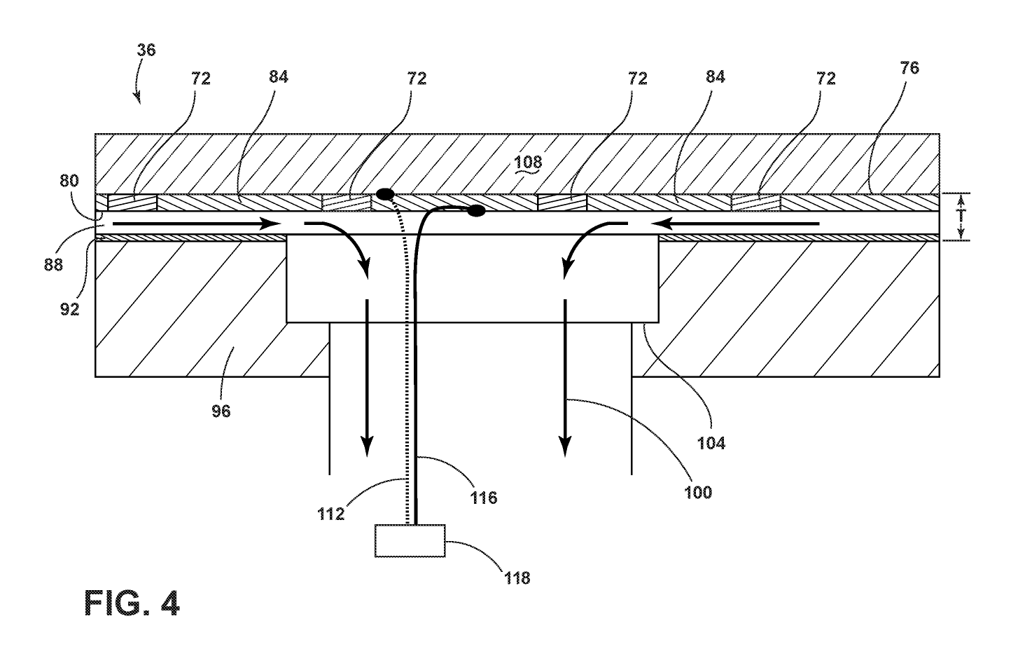

Referring now to FIGS. 3 and 4, a cross-sectional view, taken along line of one embodiment of the thermally conductive skin 36 is shown. The thermally conductive skin 36 includes a plurality of thermal electric devices 72 positioned between an upper thermally conductive member 76 and a lower thermally conductive member 80. The thermal electric devices 72 are separated from one another by thermal insulation 84. The thermal insulation 84 also separates the upper thermally conductive member 76 from the lower thermally conductive member 80. The thermal electric devices 72 are in thermal contact with the upper thermally conductive member 76 and the lower thermally conductive member 80. A free-flow fluid layer 88 is loosely attached to an underside of the lower thermally conductive member 80. The free-flow fluid layer 88 is positioned between the lower thermally conductive member 80 and an underlying air seal sheet 92. A supporting material 96 abuts an underside of the air seal sheet 92. The fluid of the free-flow fluid layer 88 in this embodiment is air. However, the free-flow fluid layer 88 can be other fluids, such as liquid, without departing from the concepts disclosed herein. The free-flow fluid layer 88 can have an induced fluid flow 100 that is provided by a fluid movement device 104, such as a fan or a pump. The fluid movement device 104 can improve heat transfer from the lower thermally conductive member 80 to/from the free-flow fluid layer 88 such that a surface 108 of the seat 28 or the seatback 32 is heated or cooled rapidly. The rapid heating and/or cooling can be rapid enough to be perceived as near-instantaneous heating and/or cooling. The supporting material 96 in this embodiment may be at least one of the seat 28 and the seatback 32. The thermally conductive skin 36 is positioned below the surface 108 of at least one of the seat 28 and the seatback 32. The thermally conductive skin 36 can have a thickness T of less than 25 mm. Alternatively, the thickness T of the thermally conductive skin 36 can be less than 20 mm. Another alternative thickness T of the thermally conductive skin 36 can be less than 15 mm. Yet another alternative thickness T of the thermally conductive skin 36 can be less than 10 mm. More specifically, the thickness T of the thermally conductive skin 36 can be between 6 mm and 10 mm. In still another alternative, the thickness T can be less than 5 mm. More specifically, the thickness T of the thermally conductive skin 36 can be between 3 mm and 5 mm.

Referring further to FIGS. 3 and 4, a first electrically conductive member 112, such as a wire, is in electrical contact with the upper thermally conductive member 76. A second electrically conductive member 116, such as a wire, is in electrical contact with the lower thermally conductive member 80. The first electrically conductive member 112 and the second electrically conductive member 116 are supplied electrical power by an electrical power supply 118. One of the first electrically conductive member 112 and the second electrically conductive member 116 is used as a positive electrode, while the other of the first electrically conductive member 112 and the second electrically conductive member 116 is used as a negative electrode. The output of the electrical power supply 118 can be continuous, modulated, analog, digital, or a combination thereof. Varying the output of the electrical power supply 118 can control the intensity of the heating or cooling of the surface 108 provided by the thermally conductive skin 36. In an embodiment that employs modulation of the output of the electrical power supply 118, the modulation can be a pulse-width modulation, such as a square-wave pulse-width modulation, where the peak width of the wave is directly proportional to the intensity of the heating or cooling of the surface 108 provided by the thermally conductive skin 36. That is, if the peak width of the wave is wider, then the electrical power supply 118 is in an on state for a longer period of time during the duration of a given on-off, or duty, cycle. Accordingly, the longer the electrical power supply 118 is in the on state of a duty cycle, the greater the intensity of heating or cooling is experienced at the surface 108. A temperature monitor, such as a thermostat, can monitor at least one of the occupant's temperature, the upper thermally conductive member's temperature, and the lower conductive member's temperature. Additionally, the temperature monitor, such as a thermostat, can be coupled to the thermally conductive skin 36 or the surface 108 of the vehicle seating assembly 24 to facilitate modulation of the electrical power supply 118. Modulation of the electrical power supply 118 can be used to alter the temperature intensity of the surface 108 that is being heated and/or cooled. The modulation can ensure that a user of the thermally conductive skin 36 remains comfortable throughout the duration of their use. In other words, the temperature monitor can be used to alter the modulation of the electrical power supply 118 so that the user need not repeatedly turn the thermally conductive skin 36 on and off as they transition outside of their comfort zone. Therefore, the thermally conductive skin 36 can automatically control the temperature of the surface 108 in cold weather to provide the vehicle seating assembly 24 as heated without becoming too hot or too cold. Similarly, the thermally conductive skin 36 can automatically control the temperature of the surface 108 in hot weather to provide the vehicle seating assembly 24 as cooled without becoming too cold or too hot. The polarity of the first electrically conductive member 112 and the second electrically conductive member 116 can be switched to change whether the thermally conductive skin 36 is heating or cooling the surface 108.

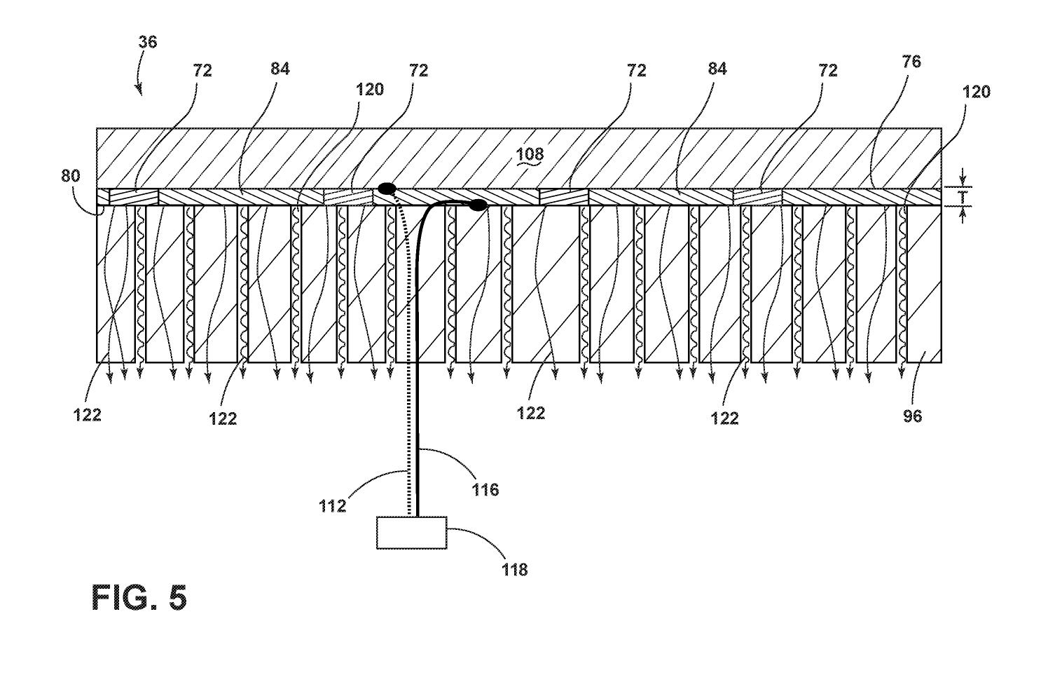

Referring now to FIG. 5 a cross-sectional view, taken along line of another embodiment of the thermally conductive skin 36 is shown. Some of the elements described above with regard to FIGS. 3 and 4 are enumerated in the present embodiment. In an effort to remain clear and concise, these common elements between embodiments will not be described repeatedly. The supporting material 96 includes a plurality of open fluid-flow structures 120. The open fluid-flow structures 120 in the supporting material 96 allow diffusion of fluid 122, such as air, to provide circulation and breathability of the lower thermally conductive member 80 to improve the efficiency and heat transfer of the thermally conductive skin 36. In other words, the supporting material 96 can be provided with the open fluid-flow structures 120 to eliminate the free-flow fluid layer 88, described above, from the thermally conductive skin 36. The use of the open fluid-flow structures 120 decreases the thickness T of the thermally conductive skin 36 when compared to the embodiments that utilize the free-flow fluid layer 88. The air can diffuse through the supporting material 96 and/or the open fluid-flow structures 120. The thermally conductive skin 36 is positioned below the surface 108 of at least one of the seat 28 and the seatback 32 in the seating embodiment shown.

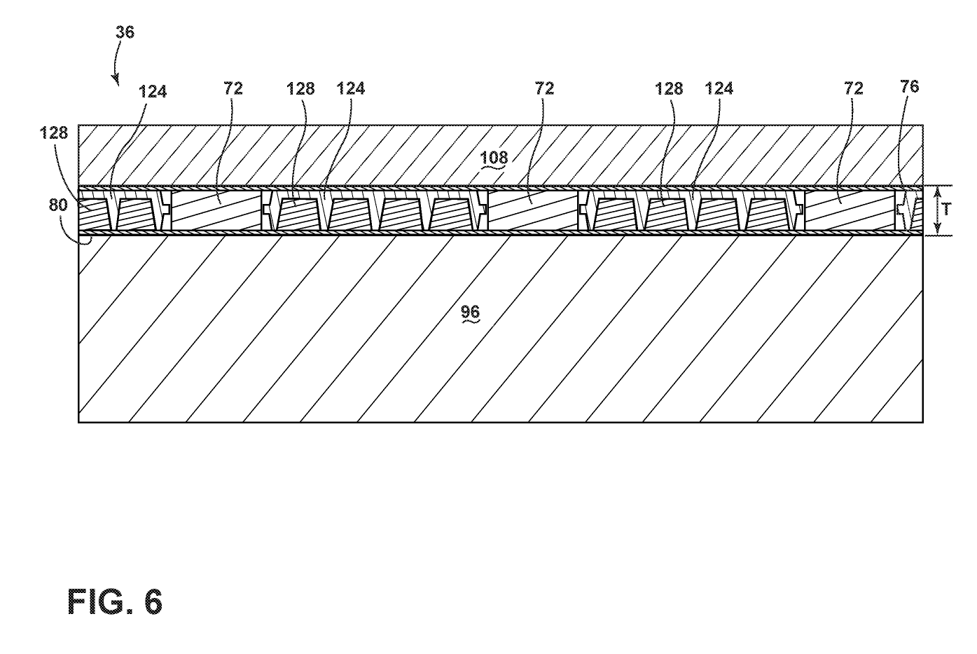

Referring now to FIG. 6, a cross-sectional view, taken along line of still another embodiment of the thermally conductive skin 36 is shown. The thermally conductive skin 36 includes the plurality of thermal electric devices 72 positioned between the upper thermally conductive member 76 and the lower thermally conductive member 80. The thermal electric devices 72 are separated from one another by a series of thermal bridge breakers 124. The series of thermal bridge breakers 124 also separates the upper thermally conductive member 76 from the lower thermally conductive member 80. The series of thermal bridge breakers 124 create channels 128 between the upper thermally conductive member 76 and the lower thermally conductive member 80. More specifically, the series of thermal bridge breakers 124 insulate the upper thermally conductive member 76 from the channels 128 and the lower thermally conductive member 80. The channels 128 are in contact with the lower thermally conductive member 80 and improve heat transfer away from the lower thermally conductive member 80. By improving heat transfer away from the lower thermally conductive member 80, the thermally conductive skin 36 becomes more efficient. In the present embodiment, the lower thermally conductive member 80 serves as the sink for either heat or cold depending on whether the user desires the surface 108 to be cooled or heated. That is, the undesired temperature is dumped from the upper thermally conductive member 76 to the lower thermally conductive member 80 through the thermal electric devices 72, thereby providing the surface 108 as heated or cooled.

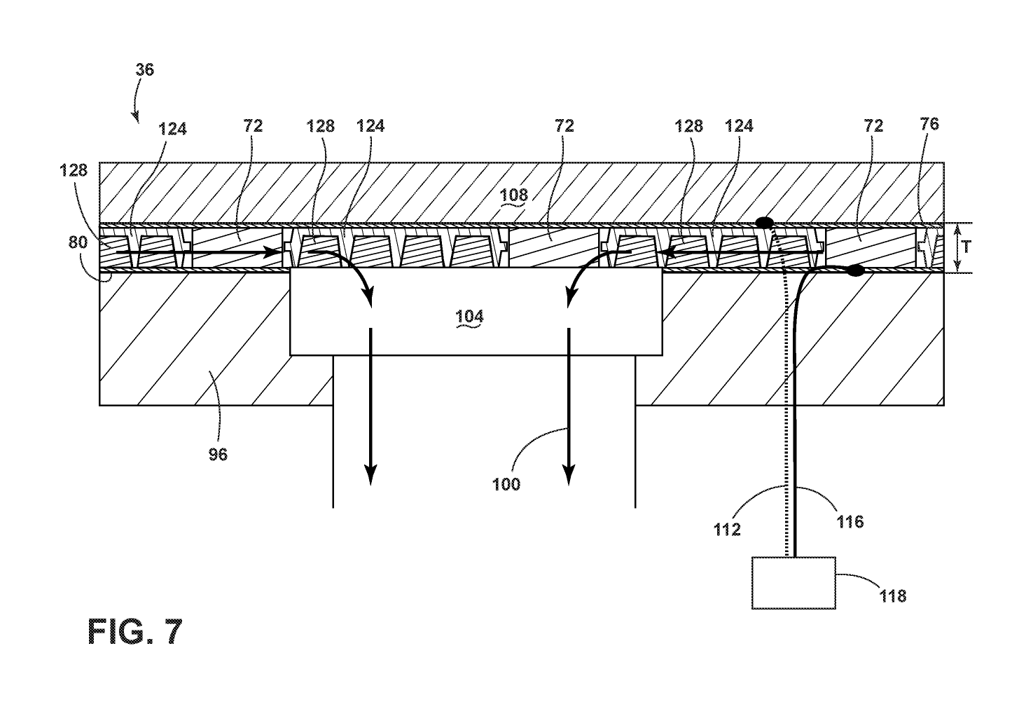

Referring to FIG. 7, a cross-sectional view, taken along line of yet another embodiment of the thermally conductive skin 36 is shown. Some of the elements described above with regard to FIG. 6 are enumerated in the present embodiment. In an effort to remain clear and concise, these common elements between embodiments will not be described repeatedly. The present embodiment employs the fluid movement device 104, such as a fan or pump. The fluid movement device 104 can provide the induced fluid flow 100 that improves heat transfer from the lower thermally conductive member 80 to the fluid within the channels 128.

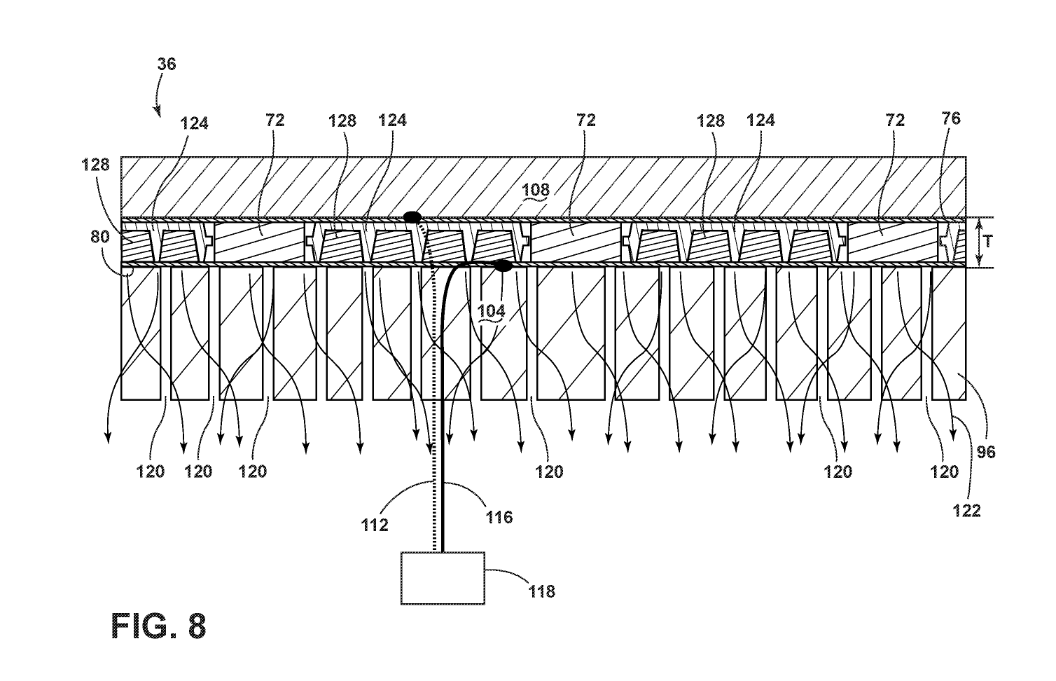

Referring now to FIG. 8, a cross-sectional view, taken along line of another embodiment of the thermally conductive skin 36 is shown. The present embodiment is similar to the embodiments described above in FIGS. 6 and 7. In an effort to remain clear and concise, common elements between embodiments will not be described repeatedly. The supporting material 96 in this embodiment is at least one of the seat 28 and the seatback 32. The supporting material 96 includes the plurality of open fluid-flow structures 120 shown through the supporting material 96 that extend vertically downward from the lower thermally conductive member 80. The thermally conductive skin 36 is positioned below the surface 108 of at least one of the seat 28 and the seatback 32 in one embodiment. The apparent thickness of the surface 108, relative to the defined thickness T of the thermally conductive skin 36, is not intended to depict a thickness of the surface 108. Rather, the surface 108 is shown conceptually as a layer of some thickness that is positioned above the thermally conductive skin 36, such that heating and/or cooling of the thermally conductive skin 36 can be accomplished. One of skill in the art will recognize that the thickness of the surface 108 can be greater than, less than, or equal to the thickness T of the thermally conductive skin 36.

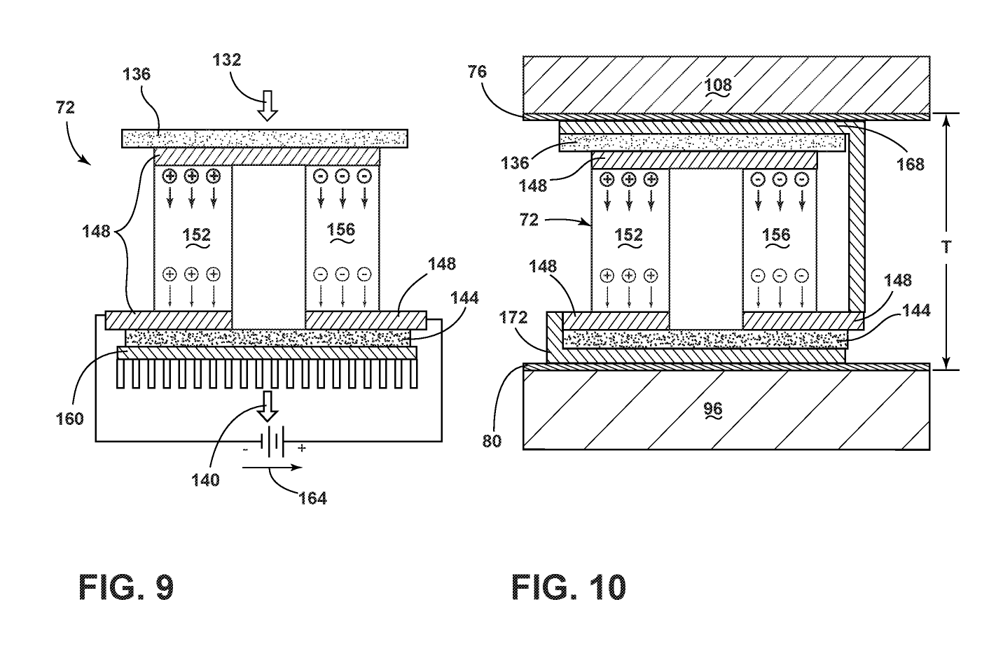

Referring to FIG. 9, one embodiment of the thermal electric devices 72 employed in the thermally conductive skin 36 is shown in more detail. The thermal electric device 72 is shown in a cooling mode. In this mode the thermal electric device 72 absorbs heat 132 from a first side 136 and rejects heat 140 from a second side 144. Abutting the underside of the first side 136 and the top side of the second side 144 are thermal conductors 148 made of thermally and/or electrically conductive material, such as copper. P-type 152 and N-type 156 semi-conductors are used to transfer heat from the first side 136 to the second side 144. A heat sink 160 is coupled to the underside of the second side 144 for rejecting heat 140. A direct current 164 can be applied to the thermal electric device 72 to provide the thermal electric device 72 in the cooling mode. Operating the thermal electric device 72 in the reverse of what is described provides the thermal electric device 72 in a heating mode. For more information on the fabrication and operation of the thermal electric devices 72 see U.S. Pat. No. 5,409,547 entitled “Thermoelectric Cooling Device for Thermoelectric Refrigerator, Process for the Fabrication of Semiconductor Suitable for Use in the Thermoelectric Cooling Device, and Thermoelectric Refrigerator Using the Thermoelectric Cooling Device,” U.S. Pat. No. 6,288,321 entitled “Electronic Device Featuring Thermoelectric Power Generation,” and U.S. Pat. No. 6,620,994 entitled “Thermoelectric Generators,” which are herein incorporated by reference in their entirety.

Referring now to FIG. 10, an additional embodiment of the thermal electric device 72 described above in FIG. 9 is shown. In this embodiment the upper thermally conductive member 76 is in thermal contact with the first side 136 of the thermal electric device 72 by way of a first coupling member 168. The lower thermally conductive member 80 is in thermal contact with the second side 144 of the thermal electric device 72 by way of a second coupling member 172. Additionally, the first coupling member 168 and the second coupling member 172 are in electrical contact with the thermal conductors 148. The first coupling member 168 and the second coupling member 172 are electrically and/or thermally conductive.

The thermally conductive skin 36 described in the present disclosure can have the thickness T be less than 25 mm. The thin nature of the thermally conductive skin 36 enables its use in close proximity to a user's skin and thereby provides a near-instantaneous heating and/or cooling of the surface 108 that it is being used to heat and/or cool. Additionally, the thin nature of the thermally conductive skin 36 results in the thermally conductive skin 36 being capable of installation directly onto the supporting material 96 and immediately beneath a non-vented surface, such as the non-ventilated trim of the vehicle seating assembly 24. Therefore, the thermally conductive skin 36 can be used as a lay-in-place option in an assembly line environment, where modular assemblies that can be optionally included are desirable and beneficial.

The thermally conductive skin 36, in addition to being exceptionally thin, is flexible and capable of local deformation such that the thermally conductive skin 36 can contour to the user. The thermally conductive skin 36 can be custom made or rolled onto a rollstock. When rolled onto the rollstock the thermally conductive skin 36 can be cut from a sheet to fit the application for which it is intended. That is, the rollstock can be a bulk supply that can be custom cut to fit a wide variety of shapes, sizes, and applications. Further, the exceptional flexibility of the thermally conductive skin 36 of the present disclosure allows extensive local deformation of a section of the thermally conductive skin 36 without exerting undue strain on another section of the thermally conductive skin 36 that is remote from the local deformation. That is, the extensive local deformation does not result in the failure or severing of components, such as the upper or lower conductive members 76, 80, in a region that is remote from the local deformation. This can be accomplished, in one embodiment, by providing stress-dissipating structures within the thermally conductive skin 36. The extensive local deformation of the thermally conductive skin 36 can occur, for example, when a user kneels on the vehicle seating assembly 24 and thereby focuses their body weight on a smaller surface area than when sitting in the vehicle seating assembly 24.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

It will be understood by one having ordinary skill in the art that construction of the described invention, and other components, is not limited to any specific material. Other exemplary embodiments of the invention disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the invention, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further, it is to be understood that such concepts are intended to be covered by the following claims, unless these claims, by their language, expressly state otherwise.

What is claimed is:

1. A thermally conductive skin comprising:
a plurality of thermal electric devices disposed between, and in thermal contact with, an upper thermally conductive member and a lower thermally conductive member, wherein the thermal electric devices are separated from one another by thermal insulation;
a free-flow fluid layer loosely attached to an underside of the lower thermally conductive member and disposed between the lower thermally conductive member and an air seal sheet; and
a supporting material abutting an underside of the air seal sheet.

2. The thermally conductive skin of claim 1, wherein the supporting material is a vehicle seat.

3. The thermally conductive skin of claim 1, wherein the thickness of the skin is less than 10 mm.

4. The thermally conductive skin of claim 1, further comprising:
an electrical power supply that includes a positive and a negative electrode, wherein the positive electrode is attached to one of the upper thermally conductive member and the lower thermally conductive member, and the negative electrode is attached to the other of the upper thermally conductive member and the lower thermally conductive member.

5. The thermally conductive skin of claim 2, further comprising:
at least one temperature monitor located proximal to an occupant of the vehicle seat to monitor at least one of the occupant's temperature, the upper thermally conductive member's temperature, and the lower conductive member's temperature.

6. The thermally conductive skin of claim 4, wherein the electrical power supply is modulated by a square-wave pulse-width modulation.

7. A thermally conductive skin comprising:
a plurality of thermal electric devices disposed between, and in thermal contact with, an upper thermally conductive member and a lower thermally conductive member, wherein the thermal electric devices are separated from one another by thermal insulation; and
a supporting material abutting an underside of the lower thermally conductive member.

8. The thermally conductive skin of claim 7, wherein the supporting material is a vehicle seat.

9. The thermally conductive skin of claim 7, wherein the supporting material has a plurality of open fluid-flow structures.

10. The thermally conductive skin of claim 7, wherein the thickness of the skin is less than 5 mm.

11. The thermally conductive skin of claim 7, further comprising:
an electrical power supply that includes a positive and a negative electrode, wherein the positive electrode is attached to one of the upper thermally conductive member and the lower thermally conductive member, and the negative electrode is attached to the other of the upper thermally conductive member and the lower thermally conductive member.

12. The thermally conductive skin of claim 8, further comprising:
at least one temperature monitor located proximal to an occupant of the vehicle seat to monitor at least one of the occupant's temperature, the upper thermally conductive member's temperature, and the lower conductive member's temperature.

13. The thermally conductive skin of claim 11, wherein the electrical power supply is modulated by a square-wave pulse-width modulation.

14. A vehicle seating assembly comprising:
a plurality of thermal electric devices disposed within a flexible thermally controlled sheet, wherein the flexible thermally controlled sheet has a thickness of less than 25 mm; and
a supporting material abutting an underside of the flexible thermally controlled sheet.

15. The vehicle seating assembly of claim 14, wherein the flexible thermally controlled sheet further comprises:
an upper thermally conductive member and a lower thermally conductive member in thermal and electrical contact with the plurality of thermal electric devices, wherein the thermal electric devices are separated from one another by thermal insulation.

16. The vehicle seating assembly of claim 14, wherein the flexible thermally controlled sheet is a compressed, non-woven fiber.

17. The vehicle seating assembly of claim 14, wherein the supporting material is a vehicle seat.

18. The vehicle seating assembly of claim 14, wherein the supporting material has a plurality of open fluid-flow structures.

19. The vehicle seating assembly of claim 15, further comprising:
an electrical power supply that includes a positive and a negative electrode, wherein the positive electrode is attached to one of the upper thermally conductive member and the lower thermally conductive member, and the negative electrode is attached to the other of the upper thermally conductive member and the lower thermally conductive member.

20. The vehicle seating assembly of claim 16, wherein the compressed, non-woven fiber is a polyester.
